(19) United States
(12) Patent Application Publication
(10) Pub. No.: US 2011/0058452 A1
(43) Pub. Date: Mar. 10, 2011

(54) Method of acquiring near offset and zero offset seismic data

(75) Inventor: Gary J. Elkington, Houston, TX (US)

(73) Assignee: PGS Onshore, Inc.

(21) Appl. No.: 12/584,474

(22) Filed: Sep. 4, 2009

(51) Int. Cl. G01V 1/16

(52) U.S. Cl. 367/37

(57) ABSTRACT

A method for seismic data acquisition includes deploying a seismic energy source at a selected position above an area of the Earth's subsurface to be evaluated. A substantially zero offset sensor is disposed proximate the seismic energy source. A plurality of seismic sensors is deployed proximate the area. At selected times the seismic energy source is actuated. Signals detected by the seismic sensors and the substantially zero offset sensor are recorded. The substantially zero offset sensor signal recording is performed for a sufficient time to detect seismic energy reflected from the subsurface.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

The invention relates generally to the field of seismic surveying. More specifically the invention relates to a method for acquiring seismic data at locations proximate a source of seismic energy.

2. Background Art

Seismic surveying, for example performed on land, includes deploying a plurality of seismic sensors, such as geophones or accelerometers at spaced apart positions in a selected pattern proximate the Earth's surface. One or more seismic energy sources are deployed at or near the surface proximate the sensors. At selected times, the sources are actuated, and signals detected by the sensors are recorded. The recordings are generally indexed with respect to the source actuation times.

FIG. 1 shows a “line” of seismic sensors R deployed at the surface 10. A seismic energy source, S, which may be an impulsive source such as dynamite, or may be a vibrator or an array of vibrators, is deployed as explained above. The source S may be actuated by certain equipment (not shown separately) in a seismic recording system 18. Signals detected by the sensors R are conducted to the recording system 18 for recording as explained above. After the source S is actuated, seismic energy travels through subsurface rock formations, e.g. at 12, until it reaches one or more acoustic impedance boundaries, e.g., at 14, in the subsurface. Such boundaries are typically at the contact between formation layers, e.g., 12 and 16. Seismic energy may be reflected from the boundary 14 and travel upwardly whereupon it is detected by the sensors R.

The seismic energy source S may have associated therewith a sensor referred to as a near-source sensor. If the source S is impulsive, such as dynamite, the near-source sensor SR may be disposed in the ground and located proximate the source S. For seismic vibrators, the near-source sensor is typically an accelerometer or similar device coupled to a baseplate portion of the vibrator. Such accelerometer is shown at BPS in FIG. 1. Signals detected by the near-source sensor SR are typically only used to detect the first arrival of seismic energy emanating directly from an impulsive source (e.g., dynamite). Such direct arrival energy may be used, for example, to evaluate surface “statics” (seismic travel time through weathered formations proximate the surface 10). With a vibrator, the baseplate accelerometer BPS may be used to generate a signal that may be cross-correlated or deconvolved with signals detected by the seismic sensors R to determine the equivalent of subsurface seismic response to an impulsive source. In some methods, the baseplate accelerometer BPS signal is combined with a signal measured by a sensor (e.g., accelerometer) on a reaction mass. Typically, the baseplate signal and the reaction mass signal have been recorded or utilized during the actual generation of the seismic vibrator signal for monitoring or control of the vibrator unit, and combined in a weighted summation referred to in the art as “ground force” used in deconvolution or inversion techniques performed during data processing.

An example three-dimensional (3D) seismic acquisition arrangement of sources S and sensors R is shown in FIG. 2. The seismic sensors R may arranged in lines along one or more selected directions, and the sources S may be arranged along lines in different directions. In some cases the sources S may be arranged in the same direction as the lines of sensors R but at different physical locations on the Earth's surface, for example as a line or lines parallel to the sensors R.

While the arrangement shown in FIG. 2 provides seismic signals having various source to sensor distances (offset) along the sensor line direction (inline) and along the source line direction (crossline), there is typically little seismic data acquired corresponding to the surface positions of each of the sources S. It is possible to move the lines of sensors R into such positions, however, such movement may decrease the efficiency with which the survey is performed.

There is a need for seismic acquisition methods that enable detecting seismic signals more efficiently without the need for deploying additional sensor lines.

### SUMMARY OF THE INVENTION

According to one aspect of the invention includes method for seismic data acquisition. A method according to this aspect of the invention includes deploying a seismic energy source at a selected position above an area of the Earth's subsurface to be evaluated. A substantially zero offset sensor is disposed proximate the seismic energy source. A plurality of seismic sensors is deployed proximate the area. At selected times the seismic energy source is actuated. Signals detected by the seismic sensors and the substantially zero offset sensor are recorded. The substantially zero offset sensor signal recording is performed for a sufficient time to detect seismic energy reflected from the subsurface.

Other aspects and advantages of the invention will be apparent from the following description and the appended claims.

### BRIEF DESCRIPTION OF THE DRAWINGS

FIG. 1 shows a prior art line of seismic sensors and a seismic source.

FIG. 2 shows placement of sources and sensors in a prior art three dimensional seismic acquisition arrangement.

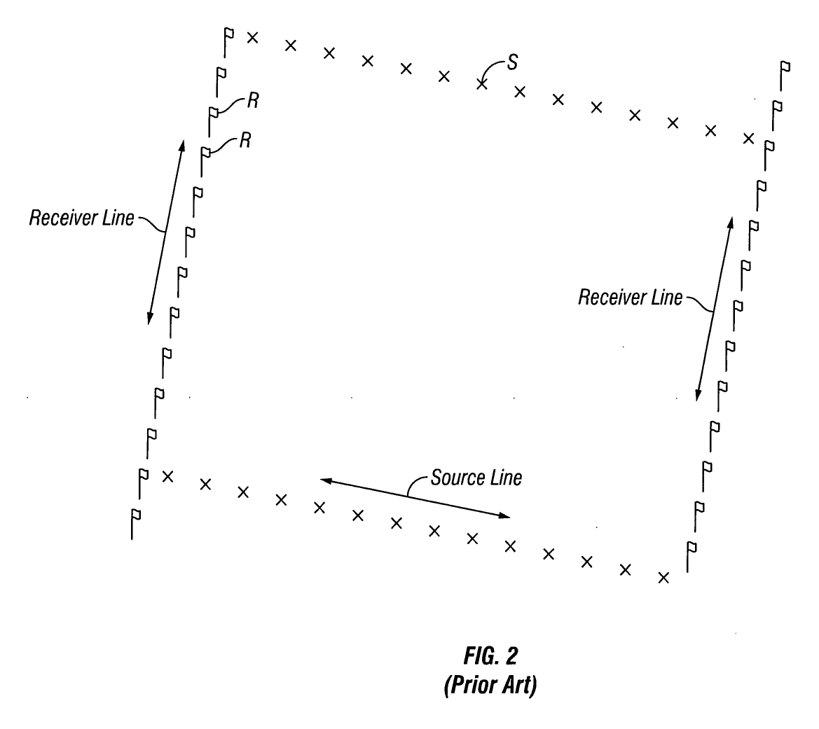

FIG. 3 shows an example of local source sensor recording for an impulsive seismic source.

FIG. 4 shows an example of local source sensor recording for a seismic vibrator.'

FIG. 5 shows an example of using source sensors located on or near other sources to record seismic signals from an actuated seismic source in an arrangement such as shown in FIG. 2.

### DETAILED DESCRIPTION

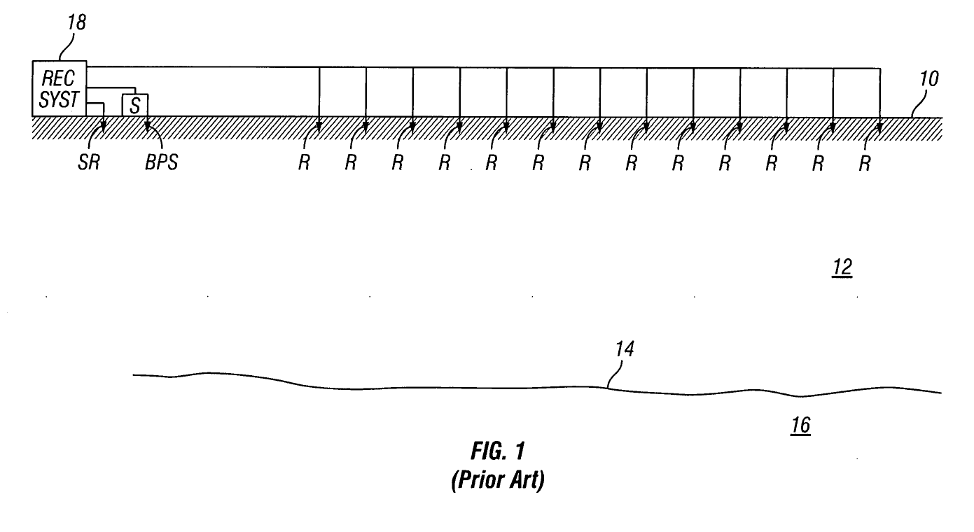

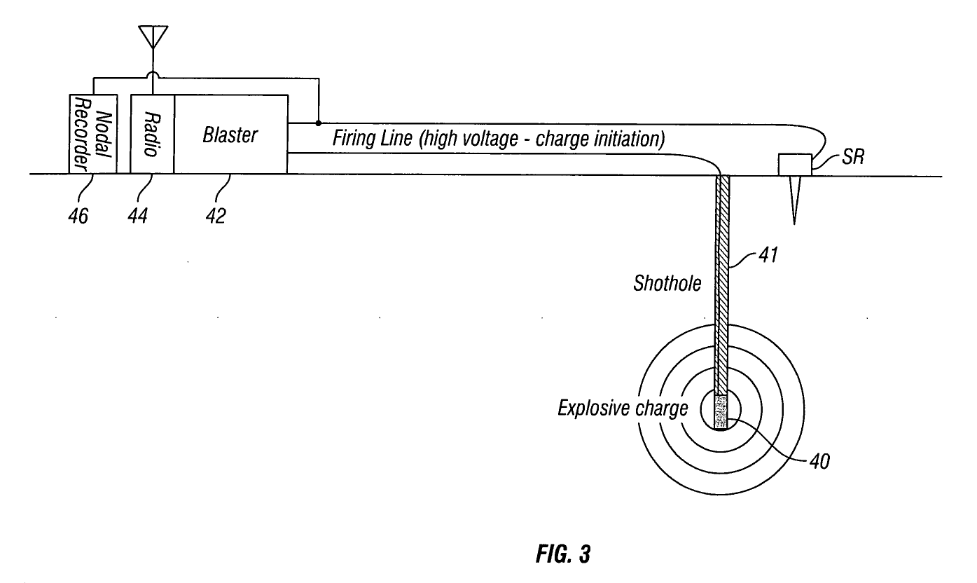

An example seismic sensor arrangement with near-source signal recording is shown in FIG. 3 for use with impulsive seismic sources (e.g., dynamite). The source 40, which may be an explosive charge, is placed in a suitable hole 41 at a selected depth below the surface. A near-source sensor SR such as a geophone or accelerometer is placed at or near the surface proximate the hole 41. The charge 40 is initiated by a blasting signal from a source controller 42. The source controller 42 may be in signal communication with the recording system (18 in FIG. 1) using a radio communication link 44 or other communication device known in the art. A data recorder 46 may be disposed proximate the source controller 42 and may record signals detected by the near-source sensor SR. In the present example, the data recorder 46 may be synchronized to an external time reference, such as timing signals from a global positioning system satellite (not shown separately). Having such an external time reference may enable accurate indexing the time of signal recording by the data recorder 46 to recordings made of the signals detected by the sensors (R in FIG. 1) deployed in sensor lines as explained in the Background section herein, and recorded by the recording system (18 in FIG. 1). Other examples may provide that the near-source sensor SR may include its own associated, time synchronized data recorder. In still other examples, the near-source sensor SR signals may be communicated to the recording system (18 in FIG. 1) using the radio link 44 or other signal coupling. Signals detected by the near-source sensor SR may be recorded for a selected length of time after the explosive charge 40 is detonated, for example, six to eight seconds. It is contemplated that the data recording of the signals produced by the near-source sensor SR will continue for a length of time substantially the same as that made by the recording system (18 in FIG. 1) for the signals generated by the seismic sensors (R in FIG. 1) in response to seismic energy reflected from the subsurface. While it is desirable to record signals detected by the near-source sensor SR for the same amount of time as recordings are made of the seismic sensor R signals, it is within the scope of the present invention to record the near-source sensor SR signals for an amount of time sufficient to include seismic energy reflected from the subsurface.

The signals detected and recorded by the near-source sensor SR during such time may be substantially zero offset seismic signals (i.e., signals recorded with a substantially collocated seismic source and seismic sensor). For purposes of defining the scope of the present invention, substantially zero offset means that the near-source sensor SR is placed so that an angle between a vertical line intersecting the source S in the hole 41 and a line intersecting the source S and the near-source sensor SR is at most five degrees. Another suitable definition of substantially zero offset is that a difference in seismic travel time between the source S and the near source sensor SR being along the same vertical line and the near-source sensor SR being offset from vertical with respect to the source S is at most five percent.

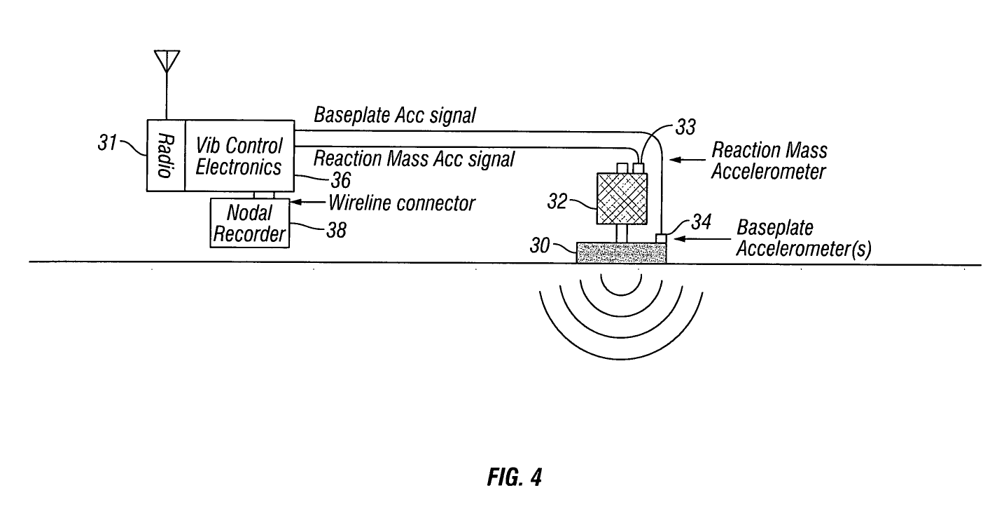

A corresponding example used with vibrator seismic energy sources is shown in FIG. 4. The vibrator may include a baseplate 30 in contact with the ground surface (10 in FIG. 1). A reactive mass 32 may be coupled to the baseplate 30 and include devices (not shown) separately to move the reactive mass 32 and baseplate 30 in response to a driver signal generated in a source controller 36. Typically, the driver signal will be a sweep or chirp through a selected frequency range. An accelerometer 34 may be coupled to the baseplate 30 to detect motion thereof. Another accelerometer 33 may be coupled to the reactive mass 32 to detect motion thereof. Signals generated by the accelerometers 33, 34 may be conducted to a local data recorder 38, substantially as explained with reference to FIG. 3. The source controller 36 may be in signal communication with the recording system (18 in FIG. 1) using a radio link 31 or any other communication device know in the art. The data recorder 38 may be time synchronized substantially as explained above. In the present example, seismic signal recording using the baseplate accelerometer 34 may continue after the end of the vibrator sweep, so as to detect substantially zero offset seismic signals reflected from the subsurface.

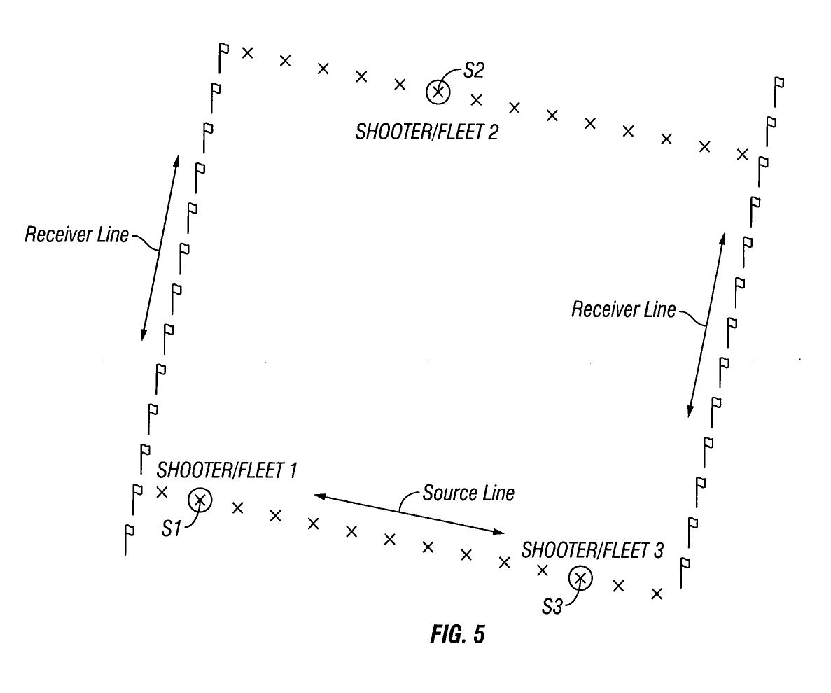

In another example, and referring to FIG. 5, the near-source sensor associated with each source (e.g., SR in FIG. 1) may be used to detect seismic signals having small offset, and/or at positions on the surface where seismic sensor lines (see FIG. 1) would ordinarily not be deployed. Such near-source sensor signals may be acquired by operating the near-source sensor data recorder (e.g., 36 in FIG. 4 or 46 in FIG. 3) during periods of time when other sources are actuated. In FIG. 5, for example, when one of the sources S1 is actuated, signals may be detected by the near-source sensors associated with sources S2 and S3 (e.g, the respective baseplate accelerometers (34 in FIG. 4)) if the sources S2 and S3 are vibrators or the near-source sensor (SR in FIG. 3) if the sources are impulsive. Correspondingly, when source S2 is actuated, signals may be detected by the near-source sensors associated with sources S1 and S3 and recorded by the respective data recorders. It is within the scope of the present invention to record near-source sensor signals at each and every source location, including the source being actuated at any particular time. Such near-source sensor signal recording may provide seismic signals corresponding to surface positions for which seismic signals would not ordinarily be recorded. The present invention is not limited in scope to use with vibrators and dynamite. The invention may be used with any other seismic energy source, including, without limitation, weight drop sources, accelerated weight drop sources and similar impulsive sources, and land-deployed air guns.

Methods for acquiring seismic signals according to the various aspects of the invention may enable detecting seismic signals more efficiently without the need for deploying additional sensor lines.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for seismic data acquisition, comprising:
deploying a seismic energy source at a selected position above an area of the Earth's subsurface to be evaluated;
deploying a substantially zero offset sensor proximate the seismic energy source deploying a plurality of seismic sensors proximate the area;
at selected times actuating the seismic energy source; and
recording signals detected by the seismic sensors and the substantially zero offset sensor, the substantially zero offset sensor signal recording performed for a sufficient time to detect seismic energy reflected from the subsurface.

2. The method of claim 1 wherein the substantially zero offsetl sensor comprises an accelerometer coupled to a baseplate of a seismic vibrator.

3. The method of claim 1 wherein the substantially zero offset sensor comprises a geophone.

4. The method of claim 1 further comprising:
deploying a plurality of seismic energy sources in a selected pattern proximate the area, each source having a substantially zero offset sensor associated therewith;
actuating each seismic energy source in the plurality thereof at selected times, and
recording signals detected by each substantially zero sensor, the substantially zero offseet sensor signal recording performed for a sufficient time to detect seismic energy reflected from the subsurface.
